(19) United States
(12) Patent Application Publication
(10) Pub. No.: US 2013/0056998 A1
(43) Pub. Date: Mar. 7, 2013

(54) Multiple Loop Fastening Strap/Leash Attachable to a Door Structure

(71) Applicants: Armando Chincarini, JR., Cypress, TX (US); Daniel Augustin Chincarini, Cypress, TX (US); Jean Elizabeth Chincarini, Cypress, TX (US)

(72) Inventors: Armando Chincarini, JR., Cypress, TX (US); Daniel Augustin Chincarini, Cypress, TX (US); Jean Elizabeth Chincarini, Cypress, TX (US)

(21) Appl. No.: 13/224,852

(22) Filed: Sep. 2, 2011

(51) Int. Cl. E05C 17/36; A44B 18/00; A44B 17/00

(52) U.S. Cl. 292/262

(57) ABSTRACT

A staggered multiple loop fastening strap/leash is securable between a door and its associated frame to provide partial access/restraint through a doorway. On one end of the strap/leash is a swivel snap that secures to an eye bolt that is screwed into a door structure. The other end has staggered loops spaced evenly apart. Each loop can go over a door knob/handle. A quick-release snap is on the strap located closer to the end with the swivel snap. When the quick-release snap is unconnected, the strap/leash becomes 2 straps.

The doorway access is restricted when the 1) swivel snap is connected to the eye bolt; 2) the quick-release snap is connected; and 3) a loop is placed over a door knob/handle. The width of the doorway opening can be increased or decreased by the selection of one of the staggered loops spaced evenly apart.

### BACKGROUND ART

Cat litter boxes are located in a variety of rooms. Most of these rooms have doors. The doorway has to remain open for cats to have access to the litter box. Many cat owners are also dog owners. Some dogs will dig in cat litter boxes to either eat feces or at a minimum create a litter box mess. An open doorway to a used litter box is an open invitation to a dog. Dogs are usually larger than cats.

A litter box is often considered unsightly. When a door is open, the litter box is usually visible from a distance. A host may wish for the cat to have access to the litter box, but to limit the litter box visibility.

Airflow circulation is important, but there are times when an individual will only desire a door to be partially open.

Current available straps/leashes/locks that secure a door to a doorway structure are intended to prevent entrance into a room. None are designed to permit limited access through a doorway; neither for animals, humans or air flow.

### OBJECT OF THE INVENTION AND SUMMARY OF INVENTION

A staggered multiple loop fastening strap/leash has a multitude of uses, including but not limited to 1) permitting doorway access to smaller animals (such as cats to a litter box) while restricting doorway access to larger animals/humans, 2) providing partial opening of doors for aesthetics or visual effects, 3) and providing partial openings that will enhanced airflow circulation. The invention provides this partial access and restraint and has features that provide for ease of use; such as:
a) A swivel snap provides easy and quick connection to an eye bolt secured to the doorway frame.
b) A quick-release snap provides an additional or faster release than the swivel snap.
c) The fastening strap/leash has staggered evenly spaced multiple loops on one end that provide an easy means to increase or decrease the partial doorway access.
d) The use of Velcro or similar product that easily secures the loop over the door handle/knob.

Litter boxes are usually placed in a bathroom or utility room. Most utility and/or bathroom doors swing open into the utility room or bathroom. The placement of the eye bolt and the staggered multiple loop strap/leash will be on the same side of the door/wall. In the above example, it would be on the bathroom or utility room side of the door. The eyebolt will be located on utility/bathroom wall on the door support structure above the door strike plate. The strap/leash also is looped around the door knob/handle on the same side as the eye bolt. This invention utilizes just one eye bolt that has to be secured to the door frame.

The doorway opening can be increased or decreased by selection of a staggered loop. The figures/drawings will feature three loops for perspective purposes, but more or less loops could be used in this invention. For perspective purposes, three loops staggered 2 inches apart provide the user the means to quickly add or decrease the doorway access/opening. For example in the above, if the interior loop is setup to provide 4 inches of doorway access, then the middle loop would provide 6 inches and the next loop would provide 8 inches. The user can quickly adjust between 4 and 8 inches of doorway access by the selection of a loop.

Once the eyebolt is secured to the wall structure and the leash/strap looped around the door handle/knob, all that remains is to secure the swivel snap to the eye bolt. This is not done by standing inside of the bathroom or utility room. This is done by standing on the outside of the bathroom and utility room. An individual merely has reached around the door by the knob/handle. The strap/leash is easily access and the individual secures the swivel snap to the eye bolt while remaining on the outside of the bathroom or utility room. To unsecure, the reverse of the above has to occurred or someone can utilized the quick-release snap.

For restricted litter box access, the doorway opening obviously has to be large enough to permit access to cats. Most cats are narrower than 4 inches, so the minimum amount of doorway access for these cats would be 4 inches. With the appropriate setup, the inside loop would be setup for a 4 inch doorway access. The next loop would achieve a 6 inch, the next 8 inch . . . . Cats are also like people, as they age they tend to get larger and wider. The extra loops provide for additional width needed that comes with age or provides for the extra access when the need arises, as when a new cat/pet comes about.

People are and dogs are normally bigger and wider than cats, so most dogs or humans would not be able to enter through such limited doorway access. In addition, dogs usually push with their nose to enter a door. Such a restriction would deter a dog from entering, since their face has extra nerve endings that make their face sensitive to pain. Since the strap/leash would not stretch, the dogs would be deterred from pushing harder to open the door.

The strap/leash could be made from woven webbing material, synthetic or leather material; so long as it provides flexibility, but does not stretch excessively so as to enlarge the doorway opening to unrestricted access. The strap/leash will be constructed in multiple versions to withstand different weights. A smaller leash would suffice for a 25 pound dog. A wider or stronger leash for a 200 pound dog.

The loops and the strap may or may not be made of the same material. The loops can be either sewn or glued to the strap; such that, they can withstand a minimum amount of pressure or weight. We will have multiple sizes of straps/leashes able to withstand varying amounts of pressure/weight of animals/humans. The figures/drawings demonstrate looped secured by stitching, but glue or other bonding agent can be used to secure loops.

Most interior door knobs are approximately 2 inches in diameter. The loop to go over such a size door knob would obviously have to be larger. A 2½ inch loop would fit easily over such a door knob. But since door knobs and handles come in a variety of sizes, the loop size will have to vary in order to fit snug enough not to easily slip off.

A more snug fit may be obtained by the application of a small piece of Velcro to decrease the size of the loop once over a doorknob/handle. The Velcro is utilized after sliding the loop over the doorknob.

Although most doorway “access openings” will be restricted to approximately 4 inches to 8 inches, the overall dimensions, specifically the length, of the multiple loop strap/leash will vary. Doorways which have open access immediately adjacent to the doorway opening will require shorter straps/leashes than those that have walls/appliances/counters etc immediately adjacent to the doorway opening. The latter type of obstructions will require longer straps to obtain the desired doorway “access opening”. This will be shown in related figures/drawings included in this application.

For aesthetics appearance, the leash/strap can be converted into a single loop. The strap/leash will be made of a material that can be cut by heavy-duty scissors. If an individual wishes to convert to a single loop, the individual would merely have to cut off the non-utilized loops.

### BRIEF DESCRIPTION OF DRAWINGS/PICTURES

FIG. 1: Side view of multiple loop strap/leash with major components visible.

FIG. 2: A strap/leash attached to a door knob and attached to an eye bolt.

FIG. 3: Opposite view of door shown in FIG. 2 with strap/leash attached to a door knob and attached to an eye bolt—quick-release snap is visible.

FIG. 4: Similar view as in FIG. 3, except door and doorway access is visible.

FIG. 5: Similar view as in FIG. 4, except an obstruction/appliance is adjacent to the doorway.

FIG. 6: “Long strap” highlighting the “end loop” with stitching.

FIG. 7: Formation of an “interior loop”.

FIG. 8: “Interior loop” with stitching and a tail.

FIG. 9: “Long strap” with 2 “interior loops” and “end loop”—stitching highlighted.

FIG. 10: Multiple loop strap with stitching highlighted.

### TABLE OF MAJOR COMPONENTS IN FIGURES

1. Eye bolt
2. Swivel Snap
3. Short Strap
4. Quick-release snap
   a. Female piece
   b. Male piece
5. Long Strap
6. Inside loop
7. Center Loop
8. End Loop

### BEST MODE

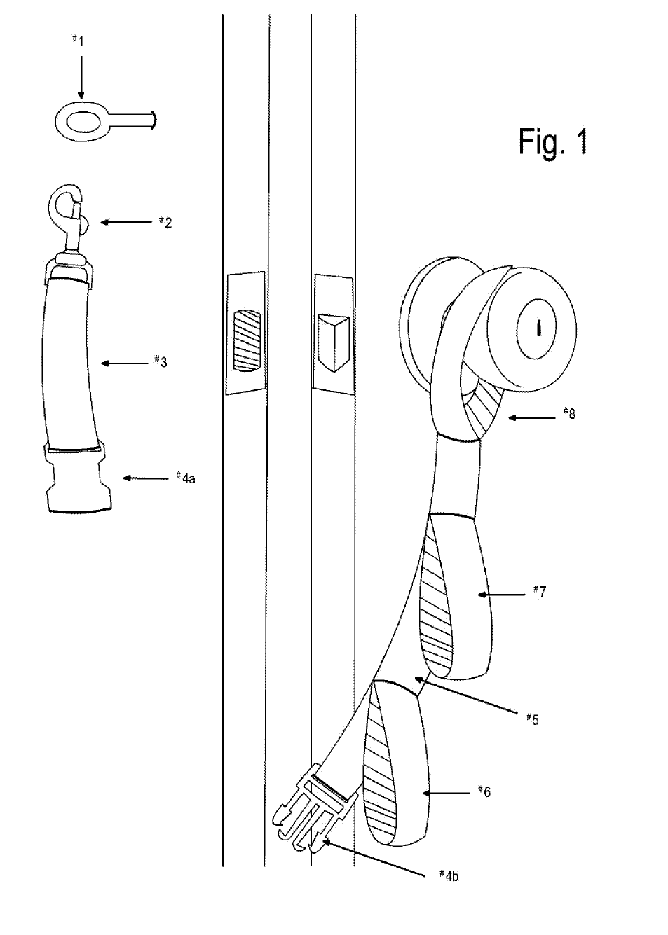

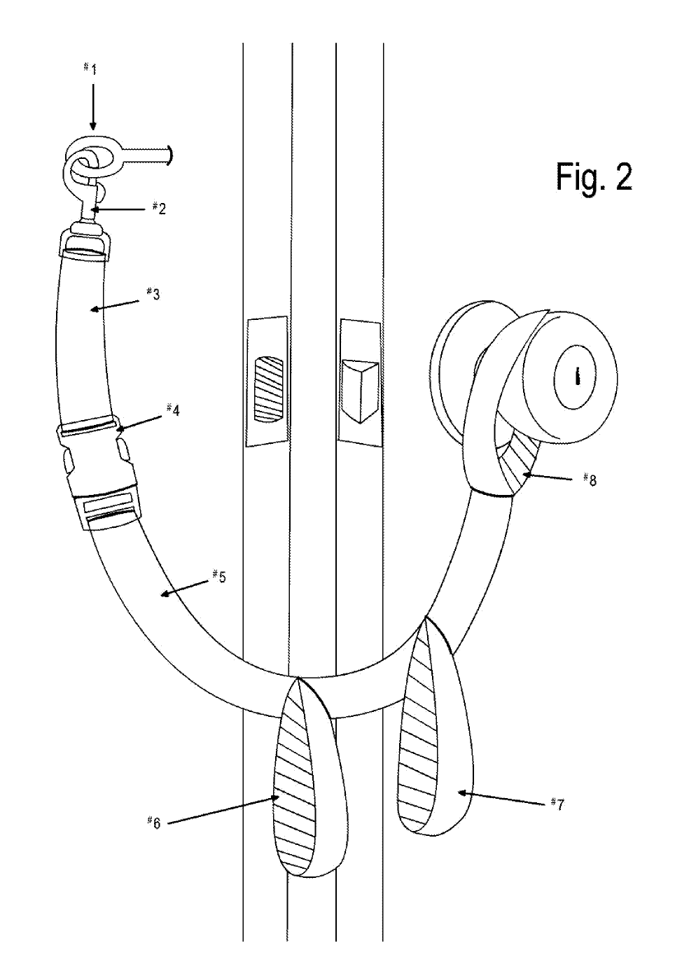

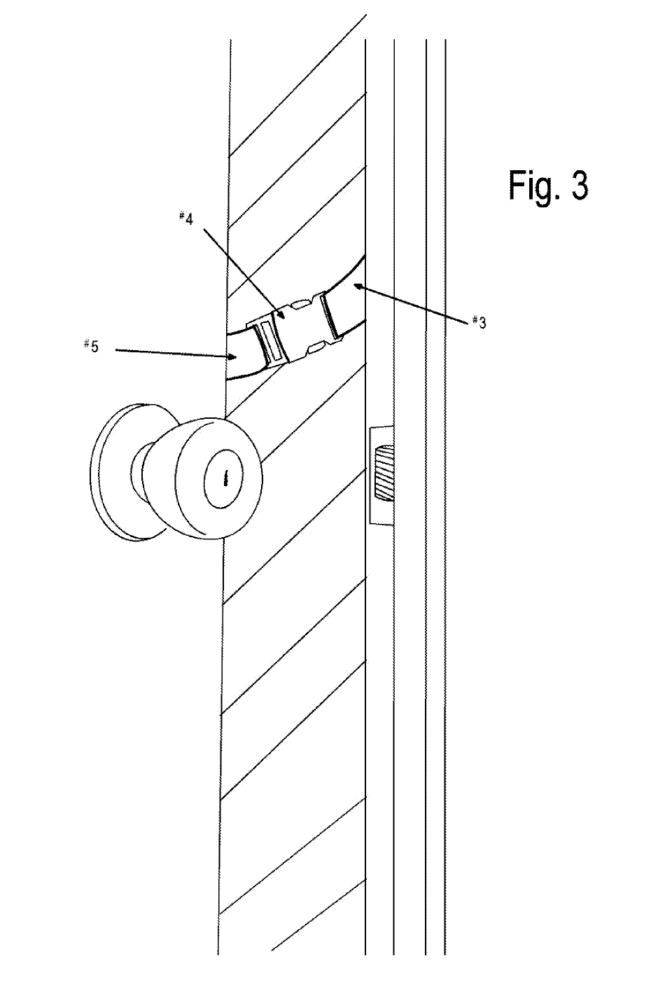

Referring to the illustrations, FIGS. 1-2 illustrate a version of the invention. FIGS. 3-12 assist in demonstrating the construction and utility of the invention.

FIG. 1 illustrates the invention disassembled. Two separate straps are evident in the illustration. The major components are identified by number. The number corresponds to the “Table of Major Components in Figures” above and the numbering is consistent throughout all Figures. The long strap (#5) is looped around a round door knob by its end loop (#8). The quick-release snap (#4) is disengaged creating two separate pieces. The swivel-snap (#2) is not connected to the eye bolt (#1).

The eye bolt (#1) is screwed into the door support structure above and to the left of the door strike plate. Not evident in the picture is the wood studs behind the wall that are found in the standard door support structure that help to secure the eye bolt. The door strike plate is just to the right of eye bolt (#1) and short strap (#3). The door strike plate is normally a small metal plate with a hole in the center located on the door structure. The purpose of illustrating the door strike plate is to give reference as to where to place the eyebolt (#1). The eyebolt (#1) is secured above the door strike plate. This will make it easier to reach through the doorway opening to connect or disconnect the strap/leash.

FIG. 2 illustrates the strap/leash connected to the eye bolt (#1) by the swivel snap (#2) and to the door knob by the end loop (#8). This figure illustrates that when fully connected the door is partially opened and only restricted access is available. This invention is not intended to restrict complete access, only to limit access. Properly installed the minimum doorway access would be approximately 4 inches. With each loop being spaced 2 inches apart, the maximum doorway access would be 8 inches for a 3-loop strap/leash.

FIG. 3 illustrates the view of the strap/leash from the other side of the door; the side in which a cat/dog/human would be trying to enter. All that is visible is the strap and the quick-release snap (#4), a section of the short strap (#3) and a section of the long strap (#5). A user will grab the leash/strap and connect the swivel-snap to the eyebolt. A 4 inch clearance is more than adequate for a user to insert their arm to connect the swivel-snap to the eyebolt.

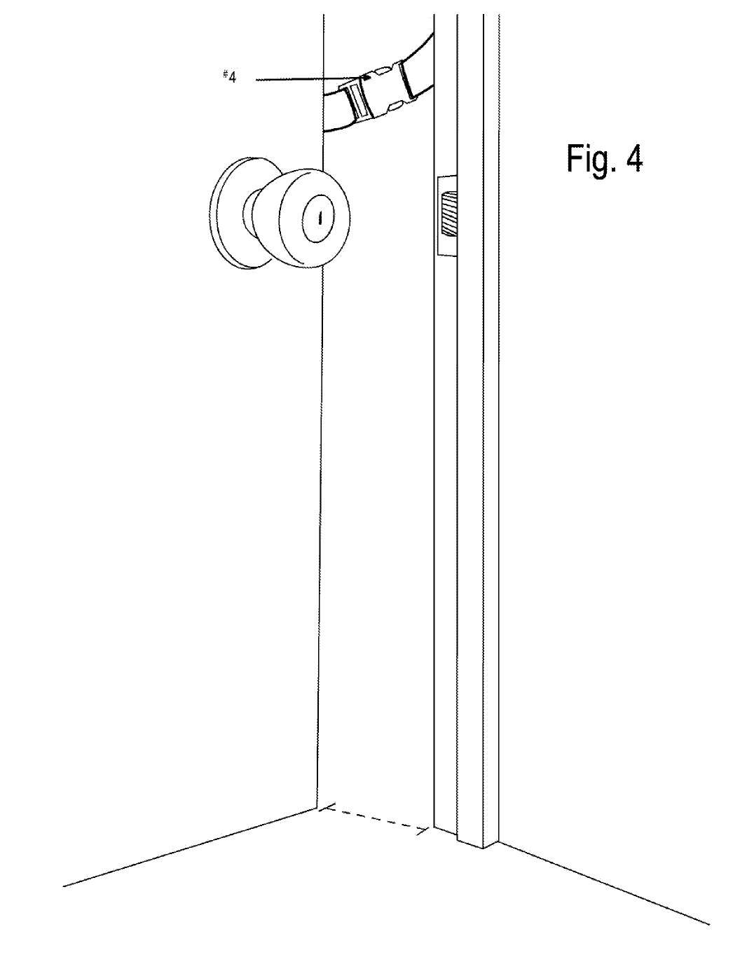

FIG. 4 is an extended view of FIG. 3. The quick-release snap (#4) is visible, along with the strap. This illustrates a doorway opening of 8 inches. Based upon the above example, this would mean that the “end loop” was looped over the door knob.

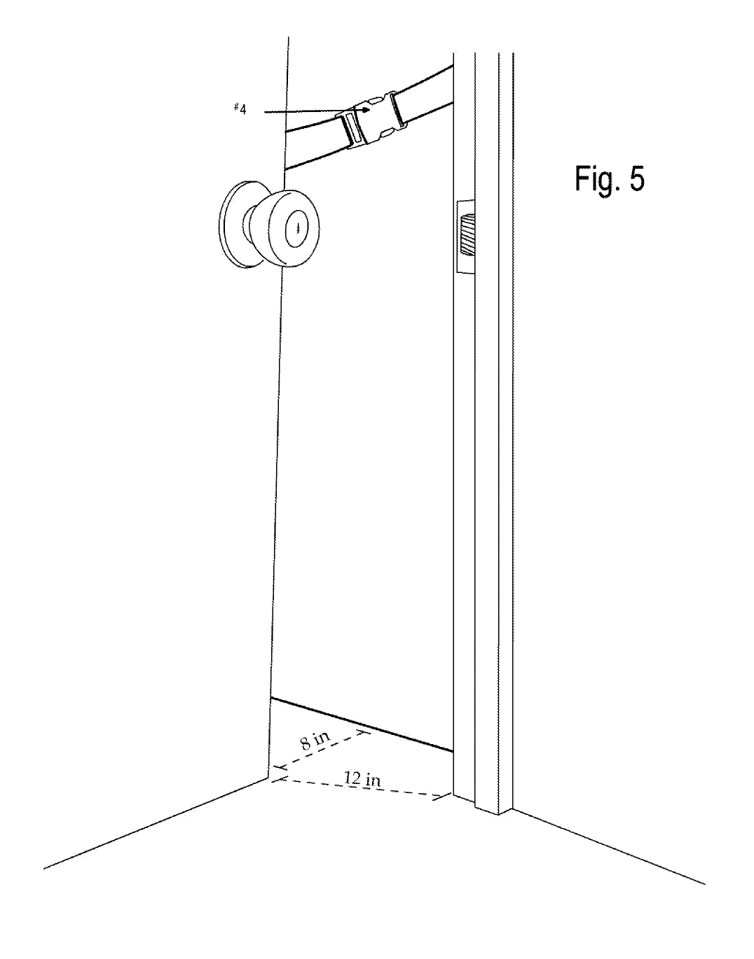

FIG. 5 is to illustrate a view where the doorway access has an obstruction and/or appliance immediately adjacent to the doorway. The quick-release snap (#4) is also visible in this example. In this case, in order to achieve an 8 inch doorway access, the door would have to be 12 inches from the door frame. Obviously a longer strap would have to be used to achieve the desired doorway access in this example. This invention would come in different lengths to accommodate such instances.

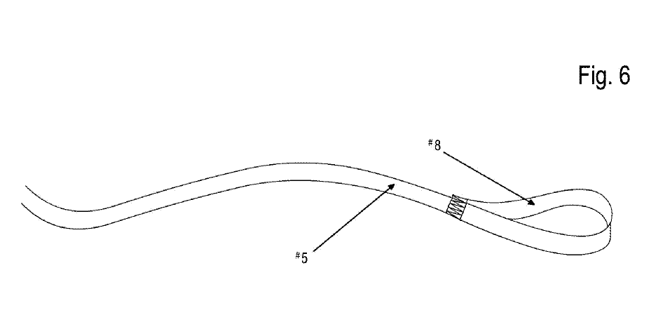

FIG. 6 through FIG. 10 demonstrates how the strap is connected together with stitching. Stitching is shown here as an example, but glue or other bonding agent could be used so long as to achieve the desired strength.

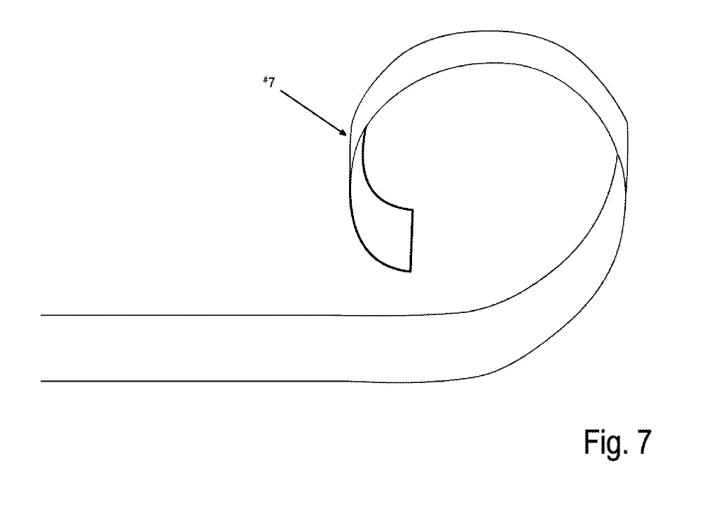

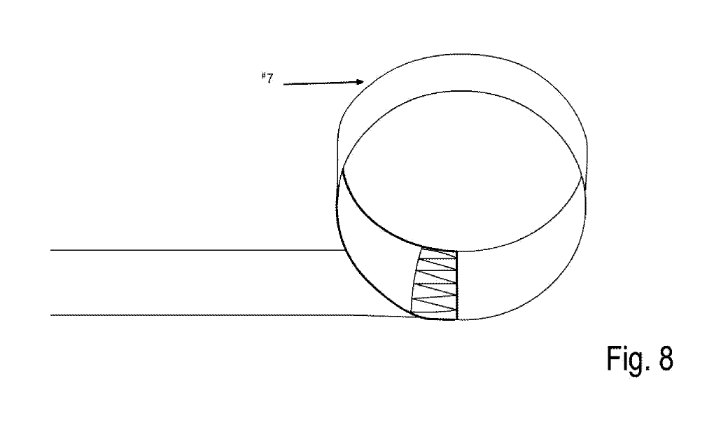

FIG. 6 demonstrates how the end loop (#8) is created and secured by stitching. FIG. 7-8 demonstrates how an interior loop is form. The stitching is what holds the loop together. A tail is left on the loop to be secured to the longer strap.

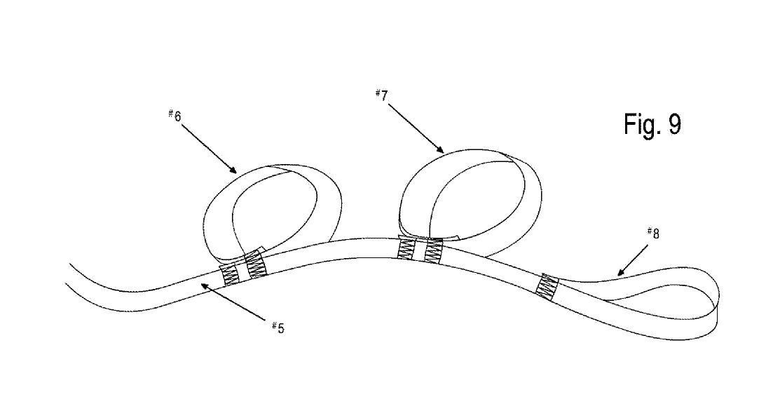

FIG. 9 illustrates the stitching on the long strap (#5). Stitching is shown creating the end loop (#8), the two interior loops (#6 & #7) and securing the interior loops' tails to the longer strap.

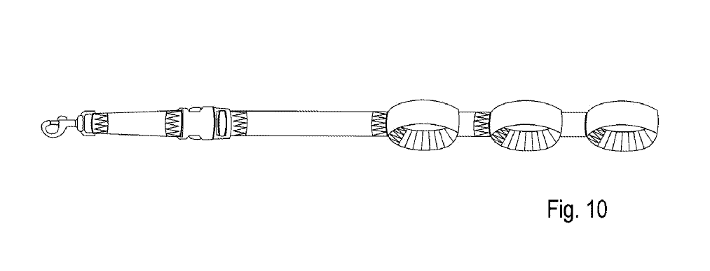

FIG. 10 illustrates the stitching on all pieces of the straps. Including each side of the quick-release snap and stitching securing the swivel snap. As stated previously, stitching is shown, but a bonding agent could also be used.

### Dimensions of Figures Shown

The overall length of the model shown is 16.5 inches. The 16.5 inches is calculated when the loops are lying flat, not when opened. The leash is shorter when loops are opened.

The eyebolt shown is 8 inches above the door strike plate on the wall in which the door closes into. A 16.5 inch flat leash connected to an eyebolt 8 inches above the door plate yields a maximum door opening of approximately 8 inches. This same size doorway opening can be achieved with shorter or longer leashes by moving the eyebolt closer or farther away from the door strike plate (higher or lower on the wall).

Each loop has a diameter of approximately 2½ inches. Most round door knobs have diameters between 1⅞ inches and 2¼ inches. The 2½ inches will easily slide over most round door knobs. The end loop is part of the long strap. The two other loops are secured to the long strap by glue or stitching. It requires almost 8 inches making a 2½ inch diameter loop. The minimum length required for an interior loop for the model shown is 11 inches. The 8 inches for the loop, a 1½ inch section to secure the loop together, plus a 1½ inch tail to secure to the longer strap.

The 3 loops are spaced 2 inches apart from each other. Once again, using the end loop shown yields a doorway access of 8 inches. Using the middle loop will yield an opening that is 2 inches narrower or a maximum door access opening of 6 inches using the model's dimension. A 4 inch door opening is the maximum door opening using the loop closest to the quick-release snap based upon the above dimensions.

Once again this is just the dimensions of the model; we expect to have multiple lengths to accommodate various doorway access openings.

### Velcro Application

Door knobs/handles come in a variety of shapes and sizes. It would be useful to have a means to make the loop smaller at times to provide a snugger or securer fit over the knob/handle. Velcro or similar products can be use within the loop to reduce the loop size once over the doorknob. Such application will reduce the size of the loop, making it more difficult to come loose.

### Convertibility to a Single Loop Strap

The model shown is a multiple loop strap/leash that is made out of fabric/leather/plastic. For either aesthetic or other reason, the multiple loops can be quickly converted to a single loop by cutting the other loops off.

Having thusly described our invention, we petition to claim the following:

1. A multiple loop leash/strap to provide partial doorway access by attaching a loop located on one end of a strap/leash over a door knob/handle with the other end possessing a swivel eye hook snap/hook that connects to an eye bolt secured to a door support.

2. The ability to easily convert from a multiple to a single loop strap.

3. The incorporation of a quick-release snap to provide full access instantaneously.

4. The incorporation of Velcro or other product to apply to the loop to better secure the loop around a variety of door knob/handle.
